(19) United States
(12) Patent Application Publication
(10) Pub. No.: US 2025/0351959 A1
(43) Pub. Date: Nov. 20, 2025

(54) Split Joint Assemblable Shelf

(71) Applicant: Sunstar Lighting Co., LTD., Zhongshan (CN)

(72) Inventor: Wangwen HUANG, Zhongshan (CN)

(21) Appl. No.: 18/676,445

(22) Filed: May 28, 2024

(30) Foreign Application Priority Data
May 15, 2024 (CN) 202421063526X

(51) Int. Cl. A47B 87/02; F16B 12/10; F16B 12/50

(52) U.S. Cl. CPC A47B 87/0246; F16B 12/10; F16B 12/50; F16B 2012/106

(57) ABSTRACT

A split joint assemblable shelf is provided, including a shelf plate assembly and a connection assembly, wherein the shelf plate assembly includes a plurality of shelf plates, a plurality of shelf rods are provided between upper and lower adjacent shelf plates, and the shelf rods and the shelf plates that are upper and lower adjacent to each other are connected through the connection assembly; at least one end of the shelf rod is provided with a mounting hole, the connection assembly includes a nut connector, the nut connector is inserted into the mounting hole in an interference fit, and the nut connector is non rotatably connected to the mounting hole. The present disclosure has a simple structure and reasonable design to avoid the occurrence of cracks when the shelf rod is tightened, making the connection convenient and stable.

### CROSS-REFERENCE

This application claims to the benefit of priority from Chinese Application No. CN202421063526X with a filing date of May 15, 2024. The content of the aforementioned applications, including any intervening amendments thereto, are incorporated herein by reference.

### TECHNICAL FIELD

The disclosure relates to the technical field of lamp shelf, in particular to a split joint assemblable shelf.

### BACKGROUND

In existing technology lamp shelves, many support rods and laminates are directly screwed, glued, or connected through L-shaped connectors. The dismantling after connection is cumbersome and the connection cannot be adjusted. Moreover, in the above structure, due to the wooden material of the shelf rod, when the shelf rod is directly tightened, it is easy for the shelf rod to crack, resulting in damage and inability to tighten, leading to the scrapping of the shelf rod and increasing production costs.

Therefore, it is necessary to develop a split joint assemblable shelf with a simple structure and reasonable design to avoid cracking when tightening shelf rods, making the connection convenient and stable.

### SUMMARY

To solve the above problems, the technical solution adopted by the present disclosure is as follows:
A split joint assemblable shelf, including a shelf plate assembly and a connection assembly, wherein the shelf plate assembly comprises a plurality of shelf plates sequentially arranged from top to bottom, a plurality of shelf rods are provided between upper and lower adjacent shelf plates, and the shelf rods and the shelf plates that are upper and lower adjacent to each other are connected through the connection assembly;
at least one end of the shelf rod is provided with a mounting hole, the connection assembly comprises a nut connector, the nut connector is inserted into the mounting hole in an interference fit, the nut connector is non rotatably connected to the mounting hole, the nut connector is provided with a threaded hole with internal threads, and the connection assembly further comprises screws;
each shelf plate is provided with a plurality of through-holes; the screws one-to-one correspond with the through-holes; after the screws pass through the through-holes, two ends of the screws are respectively located on both sides of the shelf plates; the two ends of the screw are respectively connected to the threads of the nut connectors on both sides in a screwing way, so as to ensure that each shelf rod is firmly connected with the shelf plates.

Preferably, the mounting hole is polygonal deep hole structure, and an outer contour of the nut connector is arranged correspondingly with the mounting hole.

Preferably, the screw is capable of being adjusted up and down in the mounting hole.

Preferably, a height of the nut connector is not greater than a depth of the mounting hole.

Preferably, the nut connector comprises a nut shell and a nut; the nut shell is provided with a circular deep hole, and the nut is inserted into the circular deep hole.

Preferably, the material of the nut connector is hard metal.

Preferably, the screws are multi-start threads.

Compared to prior arts, the advantageous effects of the present disclosure are shown as below:

1. The present disclosure opens polygonal mounting holes at both ends of the shelf rod, and sets nut connectors that fit with the mounting holes through interference insertion. The nut connectors are equipped with threaded holes with internal threads, at the same time, the middle of the screw is set on the through-hole of the shelf plate, so that the upper and lower adjacent shelf rods are connected to the shelf plate through screw and nut threads. External force can tighten the shelf rods to achieve the splicing and assembly of the shelf, effectively avoiding cracks when tightening the shelf rods, and the connection is stable.

2. The screw can be adjusted up and down in the mounting hole of the shelf plate, which can adjust the screw to a state where one end is long and the other end is short, so as to adjust the height between the shelf plate and meet the needs of different users. Moreover, disassembly and installation are more convenient through threaded connections.

### BRIEF DESCRIPTION OF THE DRAWINGS

FIG. 1 is a schematic diagram of the structure of the shelf rod and the nut connector in the present disclosure;

FIG. 2 is an exploded view of the shelf rod and the nut connector in the present disclosure;

FIG. 3 is an exploded view of the connection between the shelf rod, the connection assembly, and the shelf plate assembly in the present disclosure;

FIG. 4 is a schematic diagram of the structure of the present the present disclosure;

FIG. 5 is a schematic diagram of the cross-sectional structure of FIG. 4;

FIG. 6 is a partially enlarged view showing the structure at point A in FIG. 5;

FIG. 7 is a schematic diagram of the installation of the shelf rod and the nut connector;

FIG. 8 is a structural schematic diagram of the screw.

The reference numbers in the drawings: 1—shelf rod, 2—shelf plate assembly, 3—connection assembly, 11—mounting hole, 21—shelf plate, 31—nut connector, 33—screw, 21a—through-hole, 311—nut shell, 312—threaded hole.

### DETAILED DESCRIPTION OF THE EMBODIMENTS

For the convenience of understanding the present the present disclosure, a more comprehensive description of the present the present disclosure will be provided below with reference to the relevant drawings. A preferred embodiment of the present the present disclosure is shown in the relevant drawing. However, the present disclosure can be implemented in many different forms, not limited to the embodiments described herein. On the contrary, the purpose of providing these embodiments is to provide a more thorough and comprehensive understanding of the disclosed content of the present the present disclosure.

It should be noted that when a component is referred to as “fixed” to another component, it can be directly fixed to another component or there can be a centered component. When a component is considered to be “connected” to another component, it can be directly or indirectly connected to another component. The terms “vertical”, “horizontal”, “left”, “right”, “up”, “down”, “front”, “back” and similar expressions used in this article are for illustrative purposes only.

Unless otherwise defined, all technical and scientific terms used in this article have the same meanings as those commonly understood by those skilled in the art of the present disclosure. The terms used in the specification of the present disclosure in this article are only for the purpose of describing specific embodiments and are not intended to limit the present disclosure. The term “and/or” used in this article includes any and all combinations of one or more related listed items.

Combined with the accompanying drawings and specific embodiment, a further description of the present the present disclosure is provided as following:

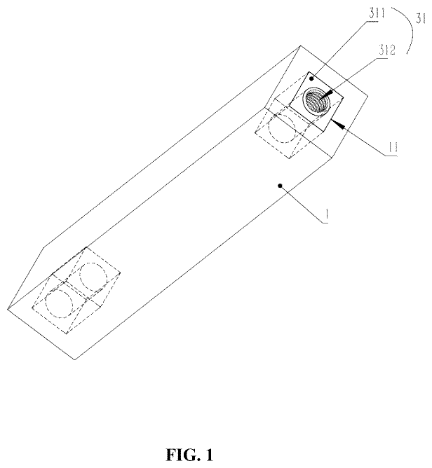

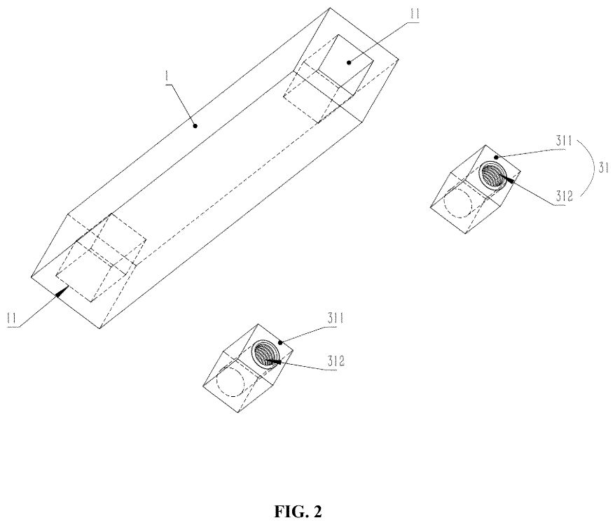

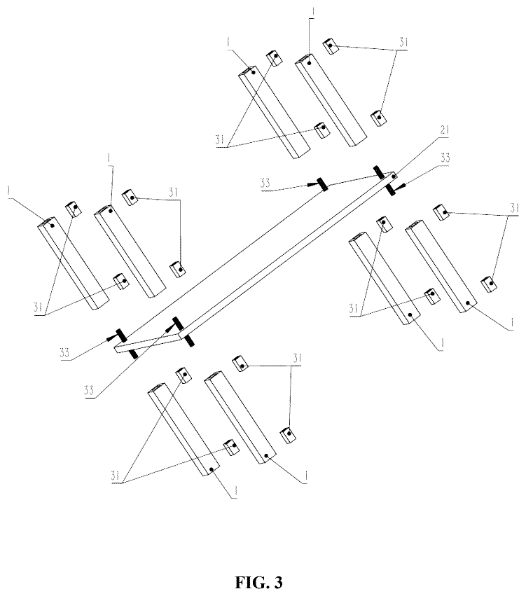

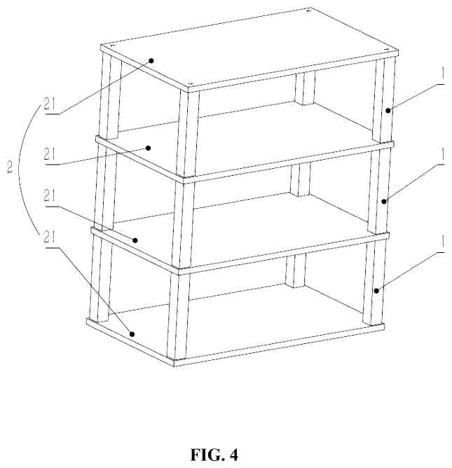

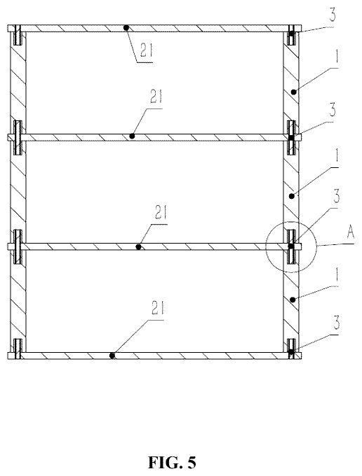

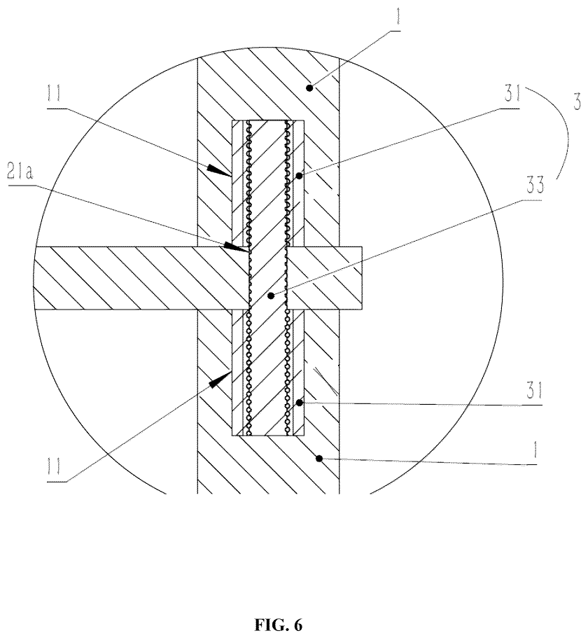

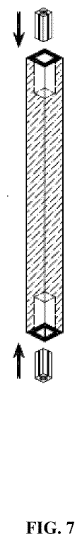

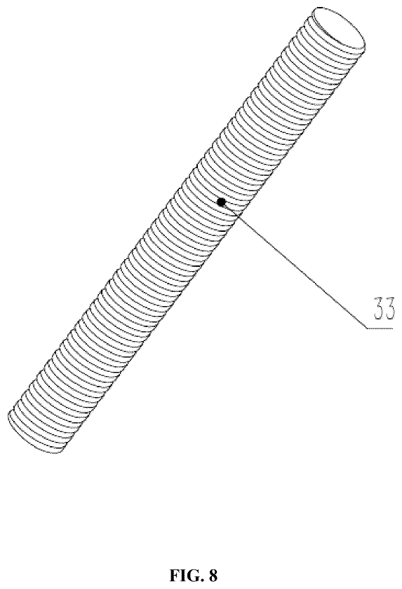

As shown in FIG. 1-8, a split joint assemblable shelf is provided, which includes a shelf plate assembly 2 and a connection assembly 3, wherein the shelf plate assembly 2 includes a plurality of shelf plates 21 sequentially arranged from top to bottom, a plurality of shelf rods 1 are provided between upper and lower adjacent shelf plates 21, and the shelf rods 1 and the shelf plates 21 that are upper and lower adjacent to each other are connected through the connection assembly 2.

At least one end of the shelf rod 1 is provided with a mounting hole 11. The connection assembly 3 includes a nut connector 31, the nut connector 31 is inserted into the mounting hole 11 in an interference fit, and the nut connector 31 is non rotatably connected to the mounting hole 11. The nut connector 31 is provided with a threaded hole 312 with internal threads, and the connection assembly 3 further includes screws 33.

Each shelf plate 21 is provided with a plurality of through-holes 21a, and the screws 33 one-to-one correspond with the through-holes 21a. After the screws 33 pass through the through-holes 21a, the two ends of the screws 33 are respectively located on both sides of the shelf plates 21. The two ends of the screw 33 are respectively connected to the threads of the nut connectors 31 on both sides in a screwing way, so as to ensure that each shelf rod 1 is firmly connected with the shelf plates 21.

In the above structure of this embodiment, the mounting hole 11 in polygonal deep hole structure are opened at both ends of the shelf rod 1, and providing a nut connector 31 that fits with the mounting holes 11 through interference insertion. The nut connector 31 is provided with threaded holes 312 with internal threads. At the same time, the middle of the screw 33 is set in the through-hole 21a of the shelf plate 21, so that the shelf rods 1 and the frame plate 21 that are adjacent upper and lower are connected with each other in a threaded connection that the screw 33 is threaded with the threaded hole 312 connected with upper and lower nuts. External force can tighten the shelf rod 1 to achieve the splicing and assembly of the shelf, effectively avoiding cracks when the shelf rod 1 is tightened, and the connection is convenient and stable, effectively avoiding cracks when the shelf rod 1 is tightened, and the connection is convenient and stable.

In this embodiment, the nut connector 31 and the mounting hole 11 use an interference insertion fit. During assembly, external force can insert the nut connector 31 into the mounting hole 11, and the connection is firm and not easy to detach.

Furthermore, as shown in FIG. 1-FIG. 8, in order to prevent the nut connector 31 from rotating relative to the mounting hole 11 under external force and improve connection reliability, the mounting hole 11 is a polygonal deep hole structure, and the outer contour of the nut connector 31 is correspondingly matched with the mounting hole 11.

Furthermore, as shown in FIG. 1-FIG. 8, in order to adjust the height between the shelf plates 21 to meet different user needs, the screw 33 is capable of being adjusted up and down in the mounting hole 11.

Furthermore, as shown in FIG. 1-FIG. 8, in order to prevent the nut connector 31 from protruding from the end face of the shelf rod 1 after being inserted into the mounting hole 11, which may affect the assembly effect and firmness of the shelf, the height of the nut connector 31 is not greater than the groove depth of the mounting hole 11.

Furthermore, in the present invention, the nut connector 31 can be integrally formed, that is, threaded holes are drilled inside the nut connector 31.

The nut connector 31 may consist of a nut shell 311 and a nut. The nut shell 311 is provided with a circular deep hole, and the nut is inserted into the circular deep hole. The threaded hole 312 is a nut with a threaded hole.

Furthermore, in order to ensure the strength of the connection assembly 3 and enhance the stability of the connection between the shelf rods 1 and the shelf plates 21 or the shelf rods 1, the material of the nut connector 31 is hard metal.

Furthermore, the screws 33 are multi-start threads.

In this embodiment, the multi-start thread can be quickly screwed in while having good self-locking properties, effectively improving connection stability.

It should be noted that, as the uppermost shelf and the lowest shelf of the entire assembled shelf, after the screw is inserted into the mounting hole of the uppermost shelf, the upper end of the screw does not extend above the uppermost shelf. Similarly, when the screw is inserted into the mounting hole of the lowest shelf, the lower end of the screw does not extend below the lowest shelf. That is, the screw will not extend beyond the end faces of the top and bottom shelves after assembled.

For skilled person in the art, various other corresponding changes and modifications can be made based on the technical solutions and concepts described above, and all these changes and modifications should fall within the scope of the claims of the present disclosure.

What is claimed is:

1. A split joint assemblable shelf, comprising a shelf plate assembly and a connection assembly, wherein the shelf plate assembly comprises a plurality of shelf plates sequentially arranged from top to bottom, a plurality of shelf rods are provided between upper and lower adjacent shelf plates, and the shelf rods and the shelf plates that are upper and lower adjacent to each other are connected through the connection assembly;
at least one end of the shelf rod is provided with a mounting hole, the connection assembly comprises a nut connector, the nut connector is inserted into the mounting hole in an interference fit, the nut connector is non rotatably connected to the mounting hole, the nut connector is provided with a threaded hole with internal threads, and the connection assembly further comprises screws;
each shelf plate is provided with a plurality of through-holes; the screws one-to-one correspond with the through-holes; after the screws pass through the through-holes, two ends of the screws are respectively located on both sides of the shelf plates; the two ends of the screw are respectively connected to the threads of the nut connectors on both sides in a screwing way, so as to ensure that each shelf rod is firmly connected with the shelf plates;
the mounting hole is polygonal deep hole structure, and an outer contour of the nut connector is arranged correspondingly with the mounting hole; and
the material of the nut connector is hard metal.

2. (canceled)

3. The split joint assemblable shelf according to claim 1, wherein the screw is capable of being adjusted up and down in the mounting hole.

4. The split joint assemblable shelf according to claim 1, wherein a height of the nut connector is not greater than a depth of the mounting hole.

5. The split joint assemblable shelf according to claim 1, wherein the nut connector comprises a nut shell and a nut; the nut shell is provided with a circular deep hole, and the nut is inserted into the circular deep hole.

6. (canceled)

7. The split joint assemblable shelf according to claim 1, wherein the screws are multi-start threads.
